(19) United States
(12) Patent Application Publication
(10) Pub. No.: US 2017/0146675 A1
(43) Pub. Date: May 25, 2017

(54) SYSTEM AND METHOD FOR RECONSTRUCTING SEISMIC DATA GENERATED BY A SPARSE SPECTRUM EMISSION

(71) Applicant: CGG SERVICES SAS, Massy, Cedex (FR)

(72) Inventors: Benoît DE CACQUERAY, Clamart (FR); Julien COTTON, Paris (FR)

(21) Appl. No.: 15/322,808

(22) PCT Filed: Jul. 8, 2014
(86) PCT No.: PCT/IB2014/001532

§ 371 Date: Dec. 29, 2016

(51) Int. Cl. G01V 1/36; G01V 1/30; G01V 1/00

(52) U.S. Cl. CPC G01V 1/36; G01V 1/005; G01V 1/308; G01V 2210/169

(57) ABSTRACT

A system and method for reconstructing an incomplete data subset in seismic exploration is disclosed. The method includes receiving data based on a first emitted signal as a complete dataset. The first emitted signal is a range of frequencies between a starting frequency and a stopping frequency. The method further includes receiving data based on a second emitted signal as an incomplete data subset. The second emitted signal is a subset of the frequencies used by the first emitted signal between the starting frequency and the stopping frequency. The method further includes creating a reconstructed dataset by supplementing the incomplete data subset with the complete dataset and generating a seismic image based on the reconstructed dataset.

### TECHNICAL FIELD

The present disclosure relates generally to seismic exploration tools and processes and, more particularly, to a system and method for reconstructing seismic data generated by a sparse spectrum emission.

### BACKGROUND

In the oil and gas industry, geophysical survey techniques are commonly used to aid in the search for and evaluation of subterranean hydrocarbon or other mineral deposits. Generally, a seismic energy source, or “source,” generates a seismic signal that propagates into the earth and is partially reflected by subsurface seismic interfaces between underground formations having different acoustic impedances. The reflections are recorded by seismic detectors, or “receivers,” located at or near the surface of the earth, in a body of water, or at known depths in boreholes, and the resulting seismic data can be processed to yield information relating to the location and physical properties of the subsurface formations. Seismic data acquisition and processing generates a profile, or image, of the geophysical structure under the earth's surface. While this profile does not provide an accurate location for oil and gas reservoirs, it suggests, to those trained in the field, the presence or absence of them.

Various sources of seismic energy have been used to impart the seismic waves into the earth. Such sources have included two general types: 1) impulsive energy sources and 2) seismic vibrator sources. The first type of geophysical prospecting utilizes an impulsive energy source, such as dynamite or a marine air gun, to generate the seismic signal. With an impulsive energy source, a large amount of energy is injected into the earth in a very short period of time. In the second type of geophysical prospecting, a vibrator is used to propagate energy signals over an extended period of time, as opposed to the near instantaneous energy provided by impulsive sources.

The seismic process employing such use of a seismic vibrator, sometimes referred to as “vibroseis,” propagates energy signals into the earth over an extended period of time or “sweep.” In such instances, energy at a starting frequency is first imparted into the earth, and the vibration frequency changes over the sweep interval at some rate until the stopping frequency is reached at the end of the interval. The difference between the starting and stopping frequencies of the sweep generator is known as the “sweep frequency range,” and the amount of time used to sweep through those frequencies is known as the sweep length. The data recorded in this way is then correlated to convert the extended source signal into an impulse. In land-based implementations the source signal is generally generated by a servo-controlled hydraulic vibrator, or “shaker unit,” mounted on a mobile base unit. In marine implementations, vibrators typically include a bell-shaped housing with a large and heavy diaphragm in its open end. The vibrator is lowered into the water from a marine survey vessel, and the diaphragm is vibrated by a hydraulic drive system similar to that used in a land vibrator. Except where expressly stated herein, “source” is intended to encompass any seismic source implementation, both impulse and vibratory, including any dry land, transition zone, or marine implementations thereof.

A seismic signal may be also generated by a SEISMOVIE™ system designed and manufactured by CGG Services SA (Massy, France). A SEISMOVIE™ system may emit energy at individual frequencies, one-by-one, until approximately the entire frequency band is emitted. While a SEISMOVIE™ system does not perform a sweep, a frequency band from the starting frequency to the stopping frequency may still be emitted to create an essentially continuous frequency dataset.

The seismic signal is emitted in the form of a wave that is reflected off interfaces between geological layers. The reflected waves are received by an array of geophones, or receivers, located at the earth's surface, which convert the displacement of the ground resulting from the propagation of the waves into an electrical signal recorded by means of recording equipment. The receivers typically receive data during the source's sweep interval and during a subsequent “listening” interval. The receivers record the particle motion or pressure in the medium (for example soil, rock, or water) at their location. The received signals can be processed to estimate the travel time from the source to the receiver. Travel time, in combination with velocity information, can be used to reconstruct the path of the waves to create an image of the subsurface.

A large amount of data may be received by the receivers and the received signals may be recorded and subjected to signal processing before the data is ready for interpretation. The recorded seismic data may be processed to yield information relating to the location of the subsurface reflectors and the physical properties of the subsurface formations. That information is then used to generate an image of the subsurface.

There are several types of seismic survey techniques such as: 2D monitoring/survey, 3D monitoring/survey, continuous monitoring and 4D monitoring/survey. A 2D survey maps the subsurface features in a vertical plane usually by arranging source positions and receiver locations on or near a single survey line. 3D surveys collects data over an area with the objective of determining spatial relations in three dimensions. Continuous and 4D monitoring, or time-lapse monitoring, involves conducting repeated seismic surveys over a given area to determine the changes in the earth's subsurface over time. Continuous and 4D monitoring may be used to monitor a reservoir during a drilling operation. 4D monitoring is typically used to monitor the movement of injected fluids into a reservoir over time to provide information that is useful in reservoir development. Injection fluids are used to increase the volume of recoverable hydrocarbons from a reservoir.

In 4D monitoring, a seismic survey acquisition is repeated at various time intervals. The time intervals can be hours, days, or weeks apart. When recording data during 4D monitoring a reflected signal is recorded over a period of time, referred to as the listening interval. During data processing only a subset of data recorded during the listening interval, called a window, is considered of interest for subsurface imaging. In order to obtain reflections in the listening interval without time aliasing, the minimum frequency spacing for frequencies at which signals are emitted by the source is:

$$df = \frac{1}{L}$$

where df=the minimum spacing between individual frequencies in Hertz (Hz); and
   L=the listening interval in seconds.
      Based on the listening interval, the minimum frequency spacing, the starting frequency, and the stopping frequency, the minimum number of frequencies at which signals are emitted during a survey can be determined.

In 4D monitoring, each frequency may be emitted at a minimum power level to achieve a minimum signal-to-noise ratio (SNR) value. The minimum SNR is determined based on data processing requirements. The SNR is the ratio of the reflected energy received by the receivers to the noise energy received by the receivers at a particular frequency. The minimum acquisition time for each 4D acquisition can be determined by dividing the sweep range by the minimum frequency spacing and multiplying by the minimum power required to achieve the minimum SNR at each frequency. The minimum acquisition time for the acquisition is the shortest amount of time in which an individual seismic exploration acquisition, covering all needed frequencies, can be accomplished. The minimum acquisition time may be a factor in determining the efficiency of an acquisition, the cost of the acquisition, or the amount of power required to complete the acquisition.

As described above, in conventional systems, a seismic signal is emitted featuring a complete spectrum, emitting approximately all or substantially all frequencies. In the digital domain, a complete spectrum is a set of spectral elements contained within a frequency range that has no missing frequencies. The emitted signal may cover a wide frequency range to enhance wavelet quality and improve geophysical inversion modeling results. In operation, there may be some seismic exploration situations where it is not feasible or necessary for the emitted signal to cover a complete spectrum. However, the use of a sparse spectrum, a set of spectral elements contained within a frequency range that is missing some frequencies, may result in inaccuracies or time aliasing in the recorded data that may result in data processing difficulties.

### SUMMARY

In accordance with one embodiment of the present disclosure, a method of reconstructing seismic data generated by a sparse spectrum emission is disclosed. The method includes receiving data based on a first emitted signal as a complete dataset. The first emitted signal is a range of frequencies between a starting frequency and a stopping frequency. The method further includes receiving data based on a second emitted signal as an incomplete data subset. The second emitted signal is a subset of the frequencies used by the first emitted signal between the starting frequency and the stopping frequency. The method further includes creating a reconstructed dataset by supplementing the incomplete data subset with the complete dataset and generating a seismic image based on the reconstructed dataset.

In accordance with another embodiment of the present disclosure, a seismic exploration system is disclosed. The system includes a seismic energy source configured to emit a seismic signal into a subsurface geology. The seismic signal is based on emitting a first seismic signal of a range of frequencies between a starting frequency and a stopping frequency, and emitting a second seismic signal of a subset of the range of frequencies between the starting frequency and the stopping frequency. The system also includes a recording unit configured to record energy from the seismic source reflected off of the subsurface geology. The recording unit is further configured to record data based on the first seismic signal as a complete dataset and record data based on the second seismic signal as an incomplete data subset. The system further includes a data processing system configured to create a reconstructed reflected dataset by supplementing the incomplete data subset with the complete dataset and generating a seismic image based on the reconstructed dataset.

In accordance with a further embodiment of the present disclosure, a non-transitory computer-readable medium is disclosed including computer-executable instructions carried on the computer-readable medium. The instructions cause a processor to receive data based on the first seismic signal as a complete dataset. The first emitted signal is a range of frequencies between a starting frequency and a stopping frequency. The instructions cause a processor to receive data based on the second seismic signal as an incomplete data subset. The second seismic signal is a subset of the range of frequencies between the starting frequency and the stopping frequency. The instructions further cause a processor to create a reconstructed reflected dataset by supplementing the incomplete data subset with the complete dataset and generating a seismic image based on the reconstructed dataset.

### BRIEF DESCRIPTION OF THE DRAWINGS

For a more complete understanding of the present disclosure and its features and advantages, reference is now made to the following description, taken in conjunction with the accompanying drawings, in which like reference numbers indicate like features and wherein:

FIGS. 1A through 1C illustrate graphs of recorded spectrum from a complete spectrum emission, a sparse spectrum emission, and a reconstructed spectrum, respectively, in accordance with some embodiments of the present disclosure;

FIGS. 2A through 2E illustrate graphs of the phase differences after windowing for data processed from a complete spectrum emission and for data reconstructed from a sparse spectrum emission in accordance with some embodiments of the present disclosure;

FIG. 3 illustrates a flow chart of an example method for reconstructing seismic data generated by a sparse spectrum emission in accordance with some embodiments of the present disclosure;

FIGS. 4A and 4B illustrate the results of a comparison of seismic data based on a complete spectrum emission to reconstructed data in accordance with some embodiments of the present disclosure;

FIG. 5 illustrates an elevation view of an example seismic exploration system configured to produce images of the earth's subsurface geological structure in accordance with some embodiments of the present disclosure; and

FIG. 6 illustrates an elevation view of an example seismic exploration system 600 configured to produce images of the earth's subsurface geological structure in accordance with some embodiments of the present disclosure.

### DETAILED DESCRIPTION

Seismic exploration surveys utilizing a signal emitted with a sparse spectrum (also referred to as a “sparse spectrum emission”) result in seismic imaging that may contain inaccuracies or discontinuities when compared to seismic imaging utilizing a signal emitted with a complete spectrum (also referred to as a “complete spectrum emission”). Therefore, according to the teachings of the present disclosure, systems and methods are presented that reconstruct data generated by a sparse spectrum emission to approximate data generated by a complete spectrum emission to allow for improved data processing and seismic imaging for seismic monitoring. The emission of a sparse spectrum, can allow for greater seismic exploration efficiency and can reduce the emission time of a source. Sparse spectrum emission also may allow for enhanced signal-to-noise ratios (SNR) at certain frequencies. A low SNR occurs when the noise energy is high relative to the reflected energy. Noise energy may be due to source signal attenuation, spherical divergence, ambient noise (from motors, generators, pumps, and other mechanical components near the source or the receiver), interference of multiple wave types, or other sources of interference. Noise energy may not be constant over the sweep range and may be higher in some portions of the frequency spectrum than in other portions. An enhanced SNR may be achieved by increasing the amount of power emitted at certain frequencies. The source may have additional time to build up the emitted power at certain frequencies due to the time saved by not emitting a complete spectrum. However, emitting a sparse spectrum may necessitate reconstruction of the generated seismic data.

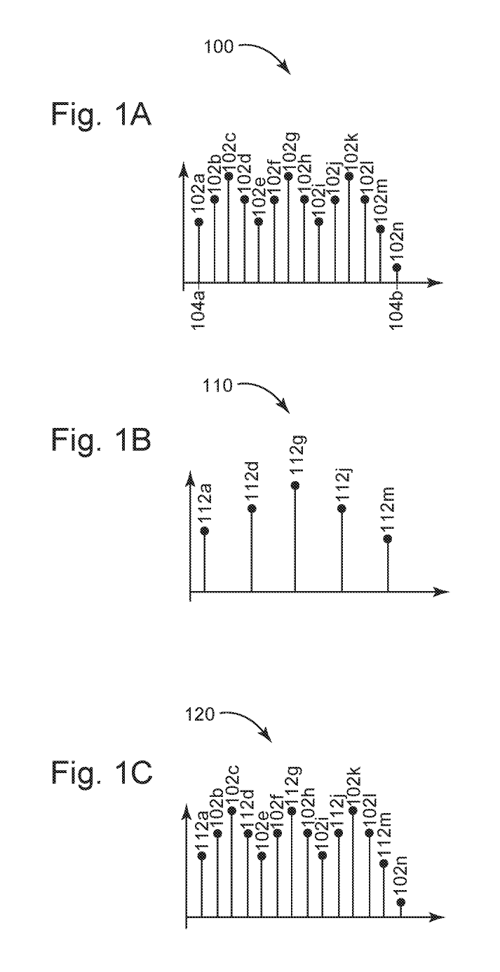

FIGS. 1A through 1C illustrate graphs of recorded spectrum from a complete spectrum emission, a sparse spectrum emission, and a reconstructed spectrum, respectively, in accordance with some embodiments of the present disclosure. FIG. 1A illustrates graph 100 of recorded spectrum 102a-102n (collectively “recorded spectrum 102”). Recorded spectrum 102 may be signals recorded from one or more signals emitted from a source as a complete spectrum. In the example shown in FIG. 1A, the emitted signals are individual monofrequency signals emitted by a source, however in other embodiments, the emitted signals may be composed of one or more sweeps from starting frequency 104a to stopping frequency 104b. In some embodiments, recorded spectrum 102 may represent signals recorded from a complete spectrum emission, effectively covering approximately every frequency between starting frequency 104a and stopping frequency 104b.

The complete spectrum emission may be emitted at approximately the same power level for each frequency in order to take advantage of the maximum intensity of the source and maximize the energy sent into the earth per time unit. The complete spectrum emission may also be emitted at various power levels. The power level can be based on the results of a previous spectrum emission, the anticipated resulting amplitude of the emitted signals, the anticipated energy of the emitted signals, the expected noise energy, or any other suitable parameter. The anticipated amplitude is based on the motion of the particles within the medium and/or the stresses in the media that is in contact or near the source. The anticipated intensity is the strength of the emitted signals when reflections of the emitted signals are received by a receiver and recorded as recorded spectrum 102. The intensity of the emitted signals decreases as the emitted signals pass through the earth's subsurface.

FIG. 1B illustrates graph 110 of recorded spectrum 112a, 112d, 112g, 112j, and 112m (collectively “recorded spectrum 112”). Recorded spectrum 112 may be signals recorded from one or more signals emitted from a source as a sparse spectrum. In the example shown in FIG. 1B, the emitted signals are individual monofrequencies emitted by a source. Recorded spectrum 112 represent a sparse spectrum emission, in which the source emits a signal approximately every third frequency. The power levels of the emitted signals in the sparse spectrum emission can be determined based on the factors described with respect to the energy levels of the emitted signals described with respect to FIG. 1A, such as the anticipated resulting amplitude of the emitted signals, the anticipated intensity of the emitted signals, the expected noise energy, or any other suitable parameter. The power level may be approximately the same for each frequency. In some embodiments, the emitted signals in the sparse spectrum emission may include sweeps of frequency subsets from the starting frequency to the stopping frequency. In other embodiments, the emitted signals in the sparse spectrum emission may be a combination of sweeps of frequency subsets and monofrequencies.

The selection of the frequencies to emit when emitting a sparse spectrum can be based in part on the undersampling factor. The undersampling factor represents the frequency subset selection and may be approximately equal to the number of frequencies represented by each emitted signal in a sparse spectrum emission. For example, for an undersampling factor of two, a signal may be emitted at one frequency for approximately every two frequencies from the complete spectrum emission. For an undersampling factor of three, a signal may be emitted at one frequency for approximately every three frequencies from the complete spectrum emission. The example shown in FIG. 1B has an undersampling factor of three. If a signal is emitted for every n frequencies, the undersampling factor is n. For a total of N frequencies, the number of emitted frequencies is:

$${N}_{e} = \frac{N}{n} \qquad ( 1 )$$

where Nₑ=the number of emitted frequencies;
   N =the total number of frequencies between the starting frequency and the stopping frequency of the complete spectrum; and
   n=the undersampling factor.
      The term “undersampling” applies also when the emitted frequencies are not regularly spaced but result in approximately Nₑ emitted frequencies.

FIG. 1C illustrates a graph 120 of recorded spectrum 102 and recorded spectrum 112 combined to create a reconstructed dataset. Data recorded as a result of a complete spectrum emission, such as recorded spectrum 102, is used to correct discontinuities in the recorded data as a result of a sparse spectrum emission, such as recorded spectrum 112. In this embodiment, the sparse spectrum emission and the use of reconstructed datasets result in an increase of the imaging rate to monitor sub-surface variations.

In some embodiments, the reconstruction of data generated by a sparse spectrum emission to approximate data generated by a complete spectrum emission in 4D seismic monitoring may include a source emitting a complete spectrum, as described with reference to FIG. 1A. A complete dataset, representing data received by the receivers and recorded by a monitoring unit after a complete spectrum emission, may be recorded. The reconstruction process may also include a source emitting a sparse spectrum, as described with reference to FIG. 1B. An incomplete data subset, representing data received by the receivers and recorded by a monitoring unit after a sparse spectrum emission, may be recorded. At the receivers, data may not be received for frequencies that are not emitted in a sparse spectrum emission. This lack of data may be referred to as a “data discontinuity.” To reconstruct an incomplete data subset with a data discontinuity at a frequency where no signal is emitted, data from the complete dataset may be inserted at frequencies where the incomplete data subset is discontinuous. The data substituted from the complete dataset may be data recorded from an emitted signal at the missing frequency. The substitution of data from a previous or subsequent complete spectrum emission survey may be used because neighboring frequencies typically carry approximately the same information and the reservoir may not change by a significant amount between surveys or the change in the reservoir may be predictable, such as a predictable change in the time delay. Thus the complete spectrum emission survey data is used to prevent data processing errors that may result from discontinuities in recorded data. The reconstructed dataset may then be used in any suitable signal processing method. In some embodiments, the reconstruction of data may include comparing the incomplete data subset with the complete dataset to determine whether the reservoir has changed significantly. If the reservoir has changed significantly, a new complete spectrum emission survey may be required. Additionally, the complete spectrum emission survey may be repeated on a regular basis, such as monthly, to capture significant changes in the reservoir. In other embodiments, the reconstruction of the data may include normalizing the incomplete data subset to account for changes in the seismic signal between the complete spectrum emission and the sparse spectrum emission, such as a change in amplitude or sweep length, changes in the soil conditions near the surface, such as the moisture content, or changes in the seismic monitoring hardware, such as replacement of a receiver or a source between surveys.

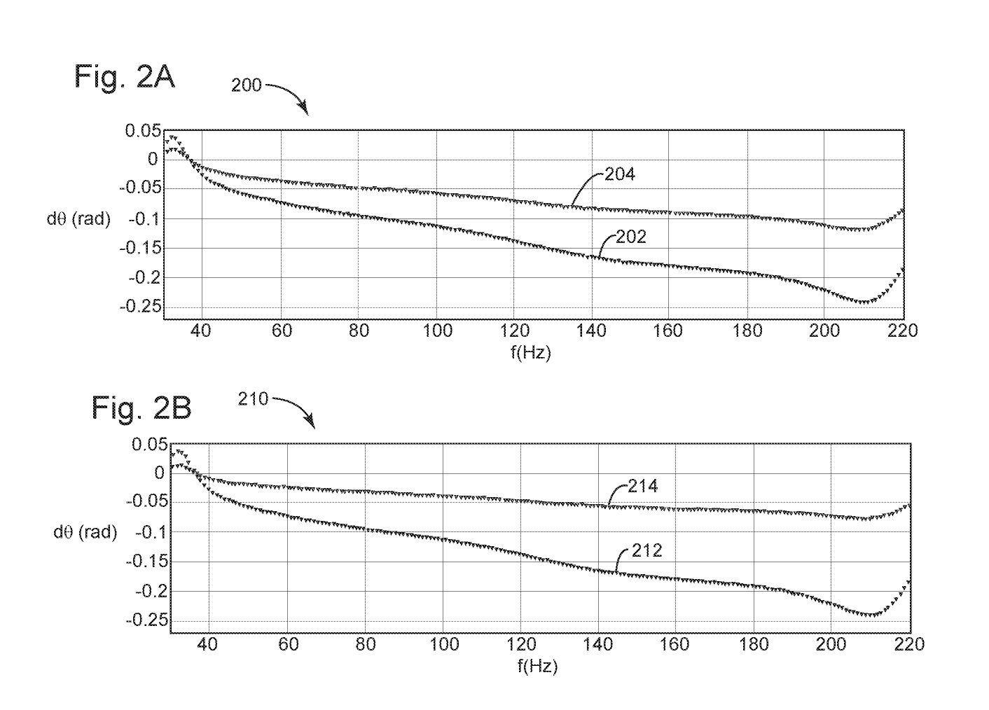

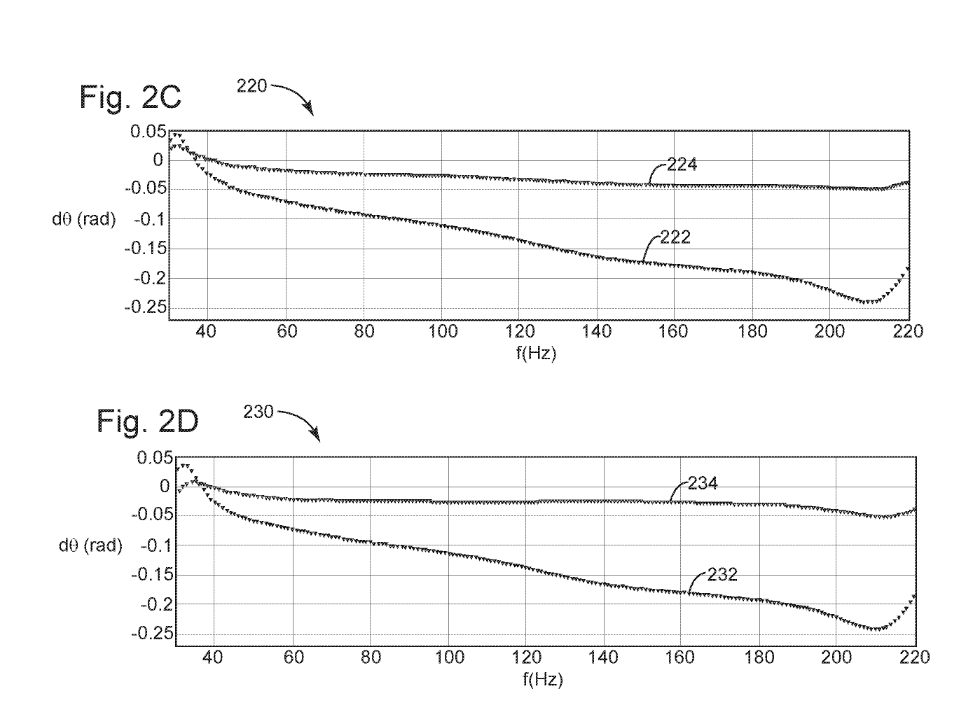

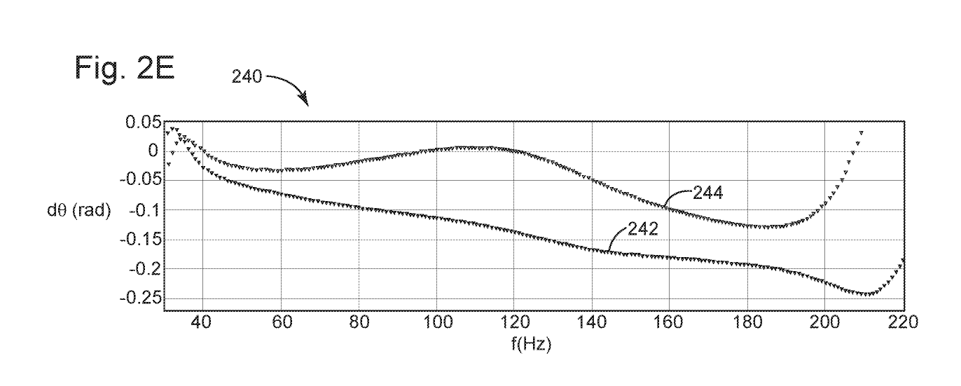

The undersampling factor may not be increased beyond the capabilities of the data processing techniques and the ability to predict data differences between the complete dataset and the reconstructed dataset. The limitations on the ability to predict data differences are illustrated in FIGS. 2A through 2E. FIGS. 2A through 2E illustrate graphs of the phase differences after windowing for data processed from a complete spectrum emission (also referred to as a “complete dataset”) and for data reconstructed from a sparse spectrum emission (also referred to as an “incomplete data subset”) in accordance with some embodiments of the present disclosure.

In FIG. 2A, graph 200 illustrates the phase difference in radians across a frequency range for a complete dataset and a reconstructed data subset where the undersampling factor of the data subset is two. Curve 202 represents the phase difference after windowing of a complete dataset. Curve 204 represents the phase difference after windowing of a reconstructed dataset. As can be seen in graph 200, the slope of curve 202 is approximately twice the slope of curve 204. In other words, the slope ratio between curve 202 and curve 204 is approximately two. Because the slope ratio between curve 202 and curve 204 is predictable or relatively constant across the frequency range, data processing may be used to reconstruct the incomplete data subset, illustrated by curve 204, for improved correlation with the complete dataset, illustrated by curve 202.

In FIG. 2B, graph 210 illustrates the phase difference in radians across a frequency range for a complete dataset and an incomplete data subset where the undersampling factor is three. Curve 212 represents the phase difference after windowing of a complete dataset. Curve 214 represents the phase difference after windowing of a reconstructed dataset. As can be seen in graph 210, the slope of curve 212 is approximately three times the slope of curve 214.

Next, in FIG. 2C, graph 220 illustrates the phase difference in radians across a frequency range for a complete dataset and an incomplete data subset where the undersampling factor is four. Curve 222 represents the phase difference after windowing of a complete dataset. Curve 224 represents the phase difference after windowing of a reconstructed dataset. As can be seen in graph 220, the slope of curve 222 is approximately four times the slope of curve 224.

In FIG. 2D, graph 230 illustrates the phase difference in radians across a frequency range for a complete dataset and an incomplete data subset where the undersampling factor is five. Curve 232 represents the phase difference after windowing of a complete dataset. Curve 234 represents the phase difference after windowing of a reconstructed dataset. As can be seen in graph 230, the slope of curve 232 is over approximately eleven times the slope of curve 234. While in FIGS. 2A-2C the slope ratio is approximately equal to the undersampling factor, in FIG. 2D the slope ratio deviates from the undersampling factor.

Finally, in FIG. 2E, graph 240 illustrates the phase difference in radians across a frequency range for a complete dataset and an incomplete data subset where the undersampling factor is six. Curve 242 represents the phase difference after windowing of a complete dataset. Curve 244 represents the phase difference after windowing of a reconstructed dataset. As can be seen in graph 240, the slope of curve 244 varies across the frequency spectrum and does not allow for calculation of a predictable, relatively constant slope ratio between curve 242 and curve 244 across the frequency range. Such an undersampling factor is not appropriate without more elaborate reconstruction processing.

Based on the data illustrated in graphs 200 through 240 in FIGS. 2A through 2E, for undersampling factors from two to four, the slope ratio can be approximated as the undersampling factor and the phase difference of the reconstructed data is approximately equal to the phase difference of the complete dataset divided by the undersampling factor. Once the undersampling factor is greater than four, the slope ratio between the complete dataset and the reconstructed dataset becomes unpredictable without more suitable processing. Therefore for undersampling factors greater than approximately four, resulting reconstructed datasets may have decreased improvement. For data processing of the reconstructed data, the arrival time may be multiplied by the undersampling factor to correct for the phase difference between the datasets.

The reconstructed dataset may be processed using any suitable data processing technique, such as a fast Fourier transform (FFT) and an inverse fast Fourier transform (iFFT), time-windowing, and computation of the time shift and amplitude variation of the reflected signal. An FFT is a signal processing technique used to convert data from the time domain to the frequency domain and an iFFT is a signal processing technique used to convert data from the frequency domain to the time domain. Windowing is a data processing technique where small subsets of the total data range are processed and analyzed. Computation of the time shift and amplitude variation of the reflected signal is used to reconstruct the paths of the waves to create an image of the subsurface or to follow 4D variations. In some embodiments, the reconstructed dataset may be processed to adjust the complete dataset portions of the reconstructed dataset to match the time delay in the incomplete data subset. The reconstructed dataset may be converted from the time domain to the frequency domain, using a FFT, for data processing, and transformed back to the time domain using an iFFT to produce an image of the earth's subsurface.

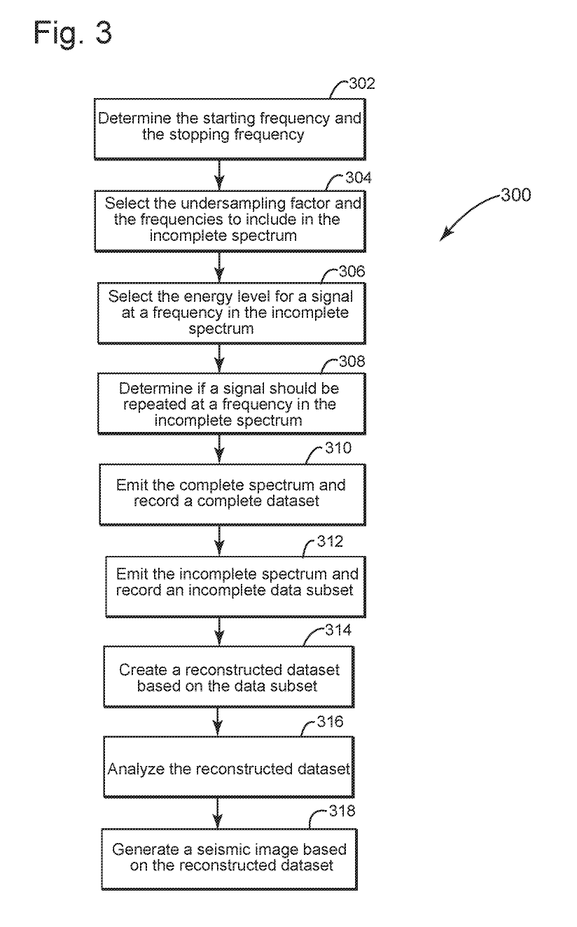

FIG. 3 illustrates a flow chart of an example method 300 for reconstructing seismic data generated by a sparse spectrum emission in accordance with some embodiments of the present disclosure. Emitting a sparse spectrum may increase seismic survey efficiency by reducing source emission time and may increase the SNR at selected frequencies by repeatedly emitting a signal at the selected frequencies. In another embodiment, the SNR gain can be obtained by lengthening the emission time at the selected frequencies from L seconds to n*L seconds, for example, or to some other time length. The steps of method 300 can be performed by a user, various computer programs, models, or any combination thereof, configured to simulate, design, and analyze data from seismic exploration signal systems, apparatuses, or devices. The programs and models may include instructions stored on a computer-readable medium and operable to perform, when executed, one or more of the steps described above. The computer-readable media can include any system, apparatus, or device configured to store and retrieve programs or instructions such as a hard disk drive, a compact disc, flash memory, or any other suitable device. The programs and models may be configured to direct a processor or other suitable unit to retrieve and execute the instructions from the computer-readable media. Collectively, the user or computer programs and models used to simulate, design, and analyze data from seismic exploration systems may be referred to as a “seismic processing tool.”

The method 300 begins at step 302, where the seismic processing tool may determine a starting frequency and a stopping frequency for a frequency spectrum to be emitted by a source. The starting frequency and the stopping frequency can be defined based on a particular implementation, the topography and/or geology of the exploration area, the presence and/or type of fluid injection, the capabilities of the seismic energy source, the projected wavelet quality or results, or any other suitable characteristic. For example, in FIG. 1A, frequency 104a is the starting frequency and frequency 104b is the stopping frequency.

In step 304, the seismic processing tool may select the undersampling factor. The undersampling factor may be selected based on the capabilities of the source, the emission time of the source, the listening time of the receivers, the capabilities of the data processing system, or any other suitable criteria. Once the undersampling factor is selected, the seismic processing tool may determine frequencies to include in the sparse spectrum emission by stepping through the frequency spectrum, beginning at the starting frequency and ending at the stopping frequency, leaving discontinuities in the emitted signal at certain frequencies based on the undersampling factor. In some embodiments, the frequencies included in the sparse spectrum may be evenly spaced. For example, in FIG. 1B, the undersampling factor is three. The seismic processing tool may determine that the frequencies corresponding to recorded spectrum 112a, 112d, 112g, 112j, and 112m are to be included in the sparse spectrum emission. In other embodiments, the frequencies included in the sparse spectrum may not be evenly spaced. For example, for an undersampling factor of three, approximately one-third of the total frequencies may be emitted but the frequencies may not have evenly spaced spectral lines. In further embodiments, the frequencies included in the sparse spectrum may be spaced based on geometric or logarithmic spacing. The frequencies included in the sparse spectrum may be individual monofrequencies and may include sampling only a few frequencies between the starting and stopping frequencies, such as approximately one or two frequencies.

In step 306, the seismic processing tool may select the power level at which a source is to emit each particular frequency of a sparse spectrum emission. The power level selected in step 306 may be the same power level for each emitted signal, for example the power level may be the maximum source power, or the signal may be emitted at a different power level for at least one emitted signal. The power level selection may be based on increasing the SNR at the particular frequency or based on the anticipated amplitude of the reflected signal. For example, for frequencies where the SNR is low despite a maximum source power intensity emission, the signal may be repeated or lengthened at those particular frequencies, as determined in step 308. Determination of frequencies where the SNR is low may be based on previously generated data, topology of the exploration area, characteristics of the vibration source, or any other suitable characteristic. For example, repetitive seismic surveys may be utilized. After an initial seismic survey (or test survey), the data recorded during the initial survey may be reviewed and the power level selected in step 306 may be based on the initial survey data. The power level selected in step 306 may also be based on data processing requirements. As the source power is limited, the seismic processing tool may select the maximum source power as the power level for all emissions at all frequencies. In such an embodiment, the frequencies with lower SNRs may be repeated, as described in step 308.

In step 308, the seismic processing tool may determine if the signal should be repeated or emitted for a longer duration at a particular frequency in the sparse spectrum. If the signal should be repeated or emitted for a longer duration at a particular frequency in the sparse spectrum, the seismic processing tool may include repeated or emitted for a longer duration emissions of a signal at the particular frequency in step 312. The signal processing tool may determine that a signal should be repeated or emitted for a longer duration at a particular frequency in the sparse spectrum when the SNR may be low at the particular frequency. Repeating or emitting for a longer duration the signal at the particular frequency may increase the SNR.

In step 310, the seismic processing tool may cause the source to emit one or more signals that cover the complete spectrum from the starting frequency to the stopping frequency, as determined at step 302. In some embodiments the signals may be consecutive. In other embodiments the signals may be nonconsecutive. A receiver may receive signals reflected off the subsurface geology and a recording unit may record the reflected signals as a complete dataset. For example the signals reflected off the subsurface geology may be recorded as recorded spectrum 102 as shown in FIG. 1A. As discussed with respect to FIG. 1C, the complete dataset can be used by the data processing system to reconstruct a dataset from a sparse spectrum emission, as will be discussed further in step 314.

In step 312, the seismic processing tool may cause the source to emit one or more signals that cover the sparse spectrum from the starting frequency to the stopping frequency, as determined in steps 302 and 304. The source may emit the sparse spectrum signals at the power levels determined in step 306. For 4D monitoring, the source may emit signals that cover the sparse spectrum at some time interval before or after the source emits the complete spectrum in step 310. A receiver may receive signals reflected off the subsurface geology and a recording unit may record the reflected signals as an incomplete data subset. In both steps 310 and 312, the signal may be emitted by a single source or multiple sources.

In step 314, the seismic processing tool may create a reconstructed dataset based on the incomplete data subset. To reconstruct a complete dataset, the seismic processing tool may begin with the incomplete data subset, as recorded from the signal emitted in step 312. Where the incomplete data subset has data discontinuities between frequencies, as determined by the undersampling factor identified in step 304, the seismic processing tool may reconstruct the dataset by supplementing the incomplete data subset with data from the complete dataset, as recorded from the signal emitted in step 310, at frequencies where the incomplete data subset has discontinuities.

At step 316, the seismic processing tool may analyze the reconstructed dataset from step 314. The analysis may include multiplying the arrival-time variations of the reconstructed dataset by the undersampling factor, as discussed with respect to FIGS. 2A through 2E. The reconstructed dataset may be further processed using any suitable data processing technique such as FFT, iFFT, windowing, and computation of the time shift and amplitude variation in order to generate an image of the subsurface. The reconstructed dataset may be processed to adjust the complete dataset portions of the reconstructed dataset to match the time delay in the incomplete data subset and to account for changes in the seismic signal between the complete spectrum emission and the sparse spectrum emission, such as a change in amplitude or sweep length.

In step 318, the seismic processing tool may generate a seismic image based on the reconstructed dataset. The reconstructed dataset may be converted from the frequency domain to the time domain, using an iFFT, to produce the seismic image. The seismic image may be utilized in future surveys or exploration of subsurface formations or for fluid injection monitoring.

Modifications, additions, or omissions may be made to method 300 without departing from the scope of the present disclosure. The order of the steps may be performed in a different manner than that described and some steps may be performed at the same time.

For example, step 312 may be performed before or after step 310. Additionally, each individual step may include additional steps without departing from the scope of the present disclosure. Further, more steps may be added or steps may be removed without departing from the scope of the disclosure. The steps of method 300 may be repeated multiple times. For example, a sparse spectrum emission may be emitted multiple times per day, for example four times per day. A complete spectrum emission may be repeated based on a longer duration, for example a complete spectrum emission may be repeated on a monthly basis. In some embodiments, the seismic processing tool may compare the incomplete data subset with the complete dataset to determine whether the reservoir has changed significantly or has changed by more than a predictable amount. If the reservoir has changed significantly or by more than a predictable amount, a new complete spectrum emission survey may be required.

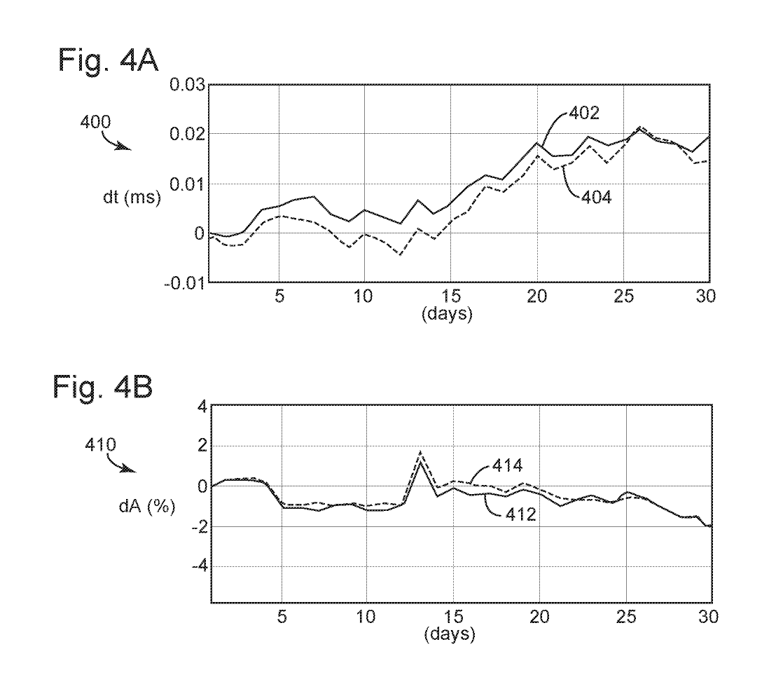

In a comparison of reconstructed data to actual data recorded during a 4D monitoring seismic survey, method 300 as described in FIG. 3, is used to reconstruct the incomplete data subsets. The incomplete data subset used to compare to the actual data has an undersampling factor of four. FIGS. 4A and 4B illustrate the results of a comparison of seismic data based on a complete spectrum to reconstructed data in accordance with some embodiments of the present disclosure. In FIG. 4A, graph 400 illustrates the time shift, in milliseconds, of surveys performed over a period of thirty days. Curve 402 represents the original data from the complete dataset. Curve 404 represents reconstructed data from the incomplete data subset with an undersampling factor of four. As can be seen in graph 400, curve 402 and curve 404 are similar.

In FIG. 4B, graph 410 illustrates the amplitude variation, in percentage, for surveys performed over a thirty day period. Curve 412 represents the original data from the complete dataset. Curve 414 represents reconstructed data from the incomplete data subset with an undersampling factor of four. As can be seen in graph 410, curve 412 and curve 414 are approximately identical.

The differences between curve 402 and curve 404, as shown in graph 400, and curve 412 and curve 414, as shown in graph 410, are small and may not introduce significant uncertainty or data processing issues for seismic exploration data analysis. Therefore method 300 may be used to decrease the total emission time of a seismic survey or enhance the energy and the SNR at particular frequencies, or both, without significantly impacting the quality of the resulting data.

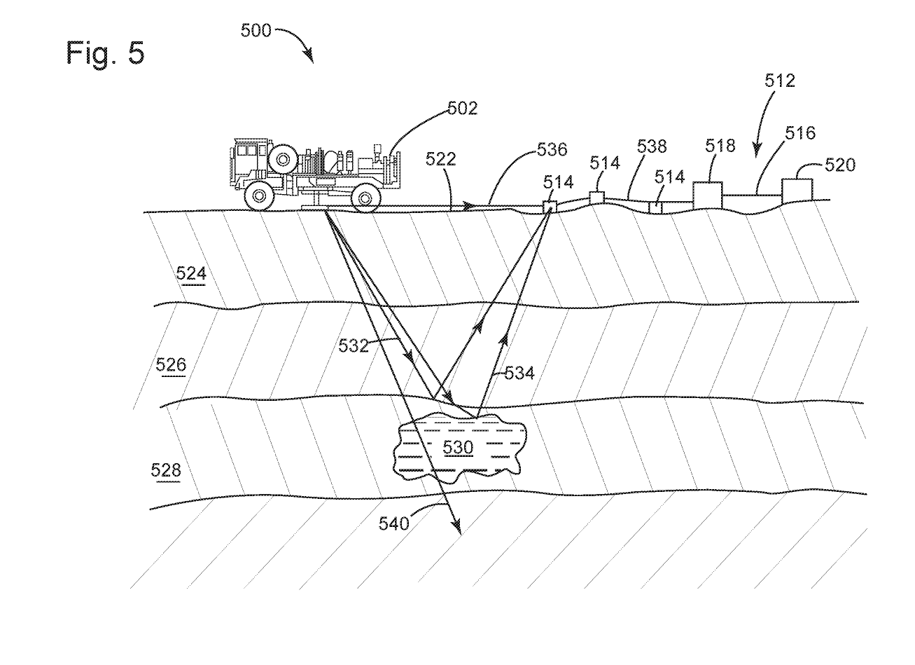

The method described with reference to FIG. 3 is used to enhance the effectiveness of a system used to emit seismic signals, receive reflected signals, and process the resulting data to image the earth's subsurface. FIG. 5 illustrates an elevation view of an example seismic exploration system 500 configured to produce images of the earth's subsurface geological structure in accordance with some embodiments of the present disclosure. The images produced by system 500 allow for the evaluation of subsurface geology. System 500 may include one or more seismic energy sources 502 and one or more receivers 514 which are located within a pre-determined exploration area. The exploration area may be any defined area selected for seismic survey or exploration. Survey of the exploration area may include the activation of seismic source 502 that radiates an acoustic wave field that expands downwardly through the layers beneath the earth's surface. The seismic wave field is then partially reflected from the respective layers as a wave front recorded by receivers 514. For example, source 502 generates seismic waves and receivers 514 record rays 532 and 534 reflected by interfaces between subsurface layers 524, 526, and 528, oil and gas reservoirs, such as target reservoir 530, or other subsurface structures. Subsurface layers 524, 526, and 528 may have various densities, thicknesses, or other characteristics. Target reservoir 530 may be separated from surface 522 by multiple layers 524, 526, and 528. As the embodiment depicted in FIG. 5 is exemplary only, there may be more or fewer layers 524, 526, or 528 or target reservoirs 530. Similarly, there may be more or fewer rays 532 and 534. Additionally, some source waves will not be reflected, as illustrated by ray 540.

Seismic energy source 502 may be referred to as an acoustic source, seismic source, energy source, and source 502. In some embodiments, source 502 is located on or proximate to surface 522 of the earth within an exploration area. A particular source 502 may be spaced apart from other similar sources. Source 502 may be operated by a central controller that coordinates the operation of several sources 502. Further, a positioning system, such as a global positioning system (GPS), may be utilized to locate and time-correlate sources 502 and receivers 514. Multiple sources 502 may be used to improve testing efficiency, provide greater azimuthal diversity, improve the signal to noise ratio, and improve spatial sampling. The use of multiple sources 502 can also input a stronger signal into the ground than a single, independent source 502. Sources 502 may also have different capabilities and the use of multiple sources 502 may allow for some sources 502 to be used at lower frequencies in the spectrum and other sources 502 at higher frequencies in the spectrum.

Source 502 may comprise any type of seismic device that generates controlled seismic energy used to perform reflection or refraction seismic surveys, such as a seismic vibrator, vibroseis, dynamite, an air gun, a thumper truck, or any other suitable seismic energy source. In some embodiments, source 502 may be a piezoelectric or other similar system, such as SEISMOVIE™, designed to generate a monofrequency. For example, the seismic signal emitted in step 310 and step 312 as described in FIG. 3 may be emitted by source 502.

Source 502 may radiate varying frequencies or one or more monofrequencies of seismic energy into surface 522 and subsurface formations during a defined interval of time. Source 502 may impart energy through a sweep of multiple frequencies or at a single monofrequency, or through a combination of at least one sweep and at least one monofrequency. A signal may be discontinuous so that source 502 does not generate particular frequencies between the starting and stopping frequency and receivers 514 do not receive or report data at the particular frequencies.

Seismic exploration system 500 may include monitoring device 512 that operates to record reflected energy rays 532, 534, and 536. Monitoring device 512 may include one or more receivers 514, network 516, recording unit 518, and processing unit 520. In some embodiments, monitoring device 512 may be located remotely from source 502.

Receiver 514 may be located on or proximate to surface 522 of the earth within an exploration area. Receiver 514 may be any type of instrument that is operable to transform seismic energy or vibrations into a voltage signal. For example, receiver 514 may be a vertical, horizontal, or multicomponent geophone, accelerometers, or optical fiber or distributed acoustic sensor (DAS) with wire or wireless data transmission, such as a three component (3C) geophone, a 3C accelerometer, hydrophone, or a 3C Digital Sensor Unit (DSU). Multiple receivers 514 may be utilized within an exploration area to provide data related to multiple locations and distances from sources 502. Receivers 514 may be positioned in multiple configurations, such as linear, grid, array, or any other suitable configuration. In some embodiments, receivers 514 may be positioned along one or more strings 538. Each receiver 514 is typically spaced apart from adjacent receivers 514 in the string 538. Spacing between receivers 514 in string 538 may be approximately the same preselected distance, or span, or the spacing may vary depending on a particular application, exploration area topology, or any other suitable parameter.

One or more receivers 514 transmit raw seismic data from reflected seismic energy via network 516 to recording unit 518. Recording unit 518 transmits raw seismic data to processing unit 520 via network 516. Processing unit 520 performs seismic data processing on the raw seismic data to prepare the data for interpretation. For example, processing unit 520 may perform the data processing techniques described in step 316 in FIG. 3. Although discussed separately, recording unit 518 and processing unit 520 may be configured as separate units or as a single unit. Recording unit 518 or processing unit 520 may include any instrumentality or aggregation of instrumentalities operable to compute, classify, process, transmit, receive, store, display, record, or utilize any form of information, intelligence, or data. Recording unit 518 may record the recorded spectrum 102 and recorded spectrum 112, as shown in FIGS. 1A and 1B, respectively. Additionally, recording unit 518 may record the complete dataset and incomplete data subsets described in steps 310 and 312 of method 300 as described with reference to FIG. 3. For example, recording unit 518 and processing unit 520 may include one or more personal computers, storage devices, servers, or any other suitable device and may vary in size, shape, performance, functionality, and price. Recording unit 518 and processing unit 520 may include random access memory (RAM), one or more processing resources, such as a central processing unit (CPU) or hardware or software control logic, or other types of volatile or non-volatile memory. Additional components of recording unit 518 and processing unit 520 may include one or more disk drives, one or more network ports for communicating with external devices, one or more input/output (I/O) devices, such as a keyboard, a mouse, or a video display. Recording unit 518 or processing unit 520 may be located in a station truck or any other suitable enclosure.

Network 516 may be configured to communicatively couple one or more components of monitoring device 512 with any other component of monitoring device 512. For example, network 516 may communicatively couple receivers 514 with recording unit 518 and processing unit 520. Further, network 514 may communicatively couple a particular receiver 514 with other receivers 514. Network 514 may be any type of network that provides communication, such as one or more of a wireless network, a local area network (LAN), or a wide area network (WAN), such as the Internet. For example, network 514 may provide for communication of reflected energy and noise energy from receivers 514 to recording unit 518 and processing unit 520.

The seismic survey emitted by source 502 may be repeated at various time intervals to determine changes in target reservoir 530. The time intervals may be months or years apart. Data may be collected and organized based on offset distances, such as the distance between a particular source 502 and a particular receiver 514 and the amount of time it takes for rays 532 and 534 from a source 502 to reach a particular receiver 514. Data collected during a survey by receivers 514 may be reflected in traces that may be gathered, processed, and utilized to generate a model of the subsurface structure or variations of the structure, for example 4D monitoring. An example of data provided via a 4D monitoring technique is shown in FIG. 4A and FIG. 4B.

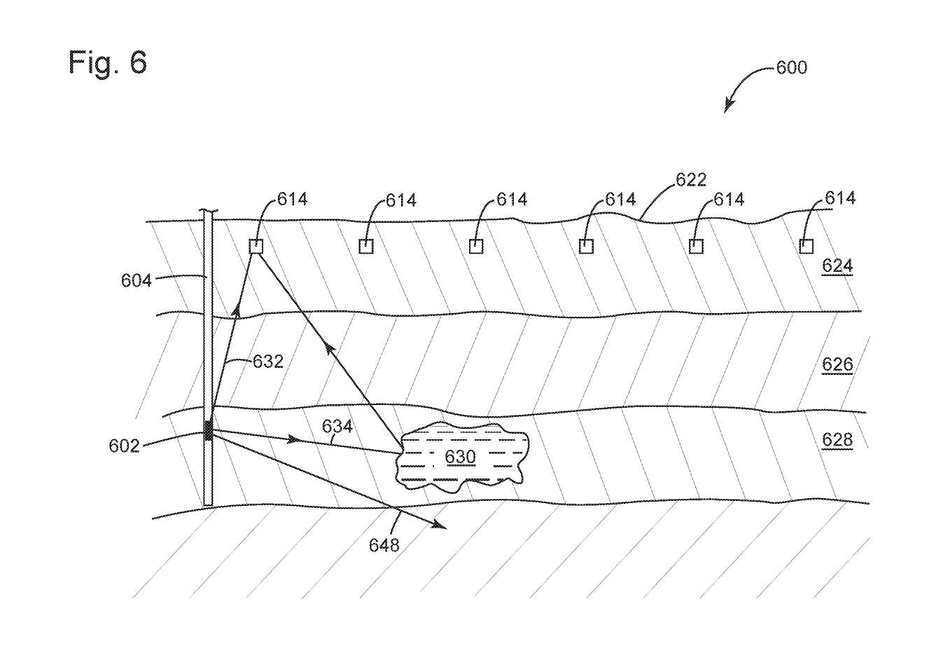

The method described with reference to FIG. 3 may also be used to enhance the effectiveness of a SEISMOVIE™ system. As another example of a seismic exploration system, FIG. 6 illustrates an elevation view of an example seismic exploration system 600 configured to produce images of the earth's subsurface geological structure in accordance with some embodiments of the present disclosure. Seismic system 600 includes seismic source 602 that may be provided in well 604. Source 602 may be any known source. For example, source 602 may be a SEISMOVIE™ source that may include piezoelectric vibrator elements that provide a wide bandwidth and high reliability/repeatability. Source 602 may radiate an acoustic wave field that expands through the layers beneath the earth's surface. For example, source 602 generates seismic waves and receivers 614 record rays 632 and 634 reflected by interfaces between subsurface layers 624, 626, and 628, oil and gas reservoirs, such as target reservoir 630, or other subsurface structures. As the embodiment depicted in FIG. 6 is exemplary only, there may be more or fewer layers 624, 626, or 628 or target reservoirs 630. Similarly, there may be more or fewer rays 632 and 634. Additionally, some source waves will not be reflected, as illustrated by ray 640.

One or more receivers 614 may be buried at a predetermined depth relative to the surface of the earth 622 or may be placed on the surface of the earth 622. The predetermined depth may be a distance larger than zero and smaller than the depth of reservoir 630, for example, predetermined depth may be approximately twelve meters. Receiver 514 may be any type of instrument that is operable to transform seismic energy or vibrations into a voltage signal. For example, receiver 614 may be a vertical, horizontal, or multicomponent geophone, accelerometers, or optical fiber or distributed acoustic sensor (DAS) with wire or wireless data transmission, such as a three component (3C) geophone, a 3C accelerometer, hydrophone, or a 3C Digital Sensor Unit (DSU).

In one embodiment, system 600 may include hundreds of receivers 614 and tens of sources 602 configured to continuously emitting seismic waves. Sources 602 may be provided in well 604 (or multiple wells 604) at a depth, for example approximately eighty meters. The data may be generated for over a period of days, weeks, or months. One or more receivers 614 may transmit raw seismic data from reflected seismic energy via a network to a recording unit, as described with reference to FIG. 5. The recording unit may transmit raw seismic data to a processing unit via a network. The processing unit may perform seismic data processing on the raw seismic data to prepare the data for interpretation. System 600 may be used to generate the recorded spectra 102 and 112 as shown in FIG. 1A and 1B.

Although discussed with reference to a land implementation, embodiments of the present disclosure are also useful in marine applications. In a marine application, monitoring device 512 may include hydrophones or accelerometers contained inside buoyant streamers, which may be towed behind a vessel. Source 502 and monitoring device 512 may be towed behind the same or a different vessel. Embodiments of the present disclosure may also be used in a seabed acquisition application. In a seabed acquisition application, where receiver 514 is placed on the seabed, monitoring device 512 may include 3C geophone and hydrophones.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. For example, the emitted signals described in FIG. 1 may be any combination of seismic sweeps and monofrequencies. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a receiver does not have to be turned on but may be configured to receive reflected energy.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. The computer processor may serve as a signal generator as described in method 300 in FIG. 3.

Embodiments of the present disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium or any type of media suitable for storing electronic instructions, and coupled to a computer system bus. Furthermore, any computing systems referred to in the specification may include a single processor or may be architectures employing multiple processor designs for increased computing capability. For example, the signal generator described in method 300 with respect to FIG. 3 may be stored in tangible computer-readable storage media.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the present disclosure is defined by the appended claims.

What is claimed is:

1. A method of reconstructing seismic data generated by a sparse spectrum emission, comprising:
receiving data based on a first emitted signal as a complete dataset, the first emitted signal spectrum is constituted of a range of frequencies between a starting frequency and a stopping frequency;
receiving data based on a second emitted signal as an incomplete data subset, the second emitted signal is a subset of the frequencies used by the first emitted signal between the starting frequency and the stopping frequency;
creating a reconstructed dataset by supplementing the incomplete data subset with the complete dataset; and
generating a seismic image based on the reconstructed dataset.

2. The method of claim 1, wherein the second emitted signal is based on an undersampling factor or a frequency subset.

3. The method of claim 2, wherein the undersampling factor is selected based on decreasing a total emission time per emitted spectrum of the seismic source.

4. The method of claim 1, wherein the second emitted signal is comprised of at least one monofrequency.

5. The method of claim 1, wherein the second emitted signal further includes:
selecting at least one particular frequency based on a signal-to-noise ratio; and
emitting the at least one particular frequency more than one time or for a longer duration to increase the signal-to-noise ratio at the at least one particular frequency.

6. The method of claim 1, further comprising:
determining, by comparing the incomplete data subset to the complete dataset, whether the incomplete data subset deviates from the complete dataset by more than a predictable amount;
based on the determination, receiving data based on a third emitted signal as a second complete dataset, the third emitted signal spectrum is constituted of a range of frequencies between a starting frequency and a stopping frequency;
creating a second reconstructed dataset by supplementing the incomplete data subset with the second complete dataset; and
generating a seismic image based on the second reconstructed dataset.

7. The method of claim 1, wherein at least one of the first emitted signal or the second emitted signal is emitted by a SEISMOVIE™ source.

8. A seismic exploration system, comprising:
a seismic source configured to:
emit a seismic signal into a subsurface geology, wherein the seismic signal is based on:
emitting a first seismic signal of a range of frequencies between a starting frequency and a stopping frequency; and
emitting a second seismic signal of a subset of the range of frequencies between the starting frequency and the stopping frequency;
a recording unit configured to record energy from the seismic source reflected off of the subsurface geology, the recording unit further configured to:
record data based on the first seismic signal as a complete dataset; and
record data based on the second seismic signal as an incomplete data subset; and
a data processing system configured to create a reconstructed reflected dataset by supplementing the incomplete data subset with the complete dataset and generate a seismic image based on the reconstructed dataset.

9. The seismic exploration system of claim 8, wherein the second seismic signal is based on an undersampling factor or a frequency subset.

10. The seismic exploration system of claim 9, wherein the undersampling factor is selected based on decreasing a total emission time of the seismic source.

11. The seismic exploration system of claim 8, wherein the second seismic signal is comprised of at least one monofrequency.

12. The seismic exploration system of claim 8, wherein the second seismic signal further includes:
selecting at least one particular frequency based on a signal-to-noise ratio; and
emitting the at least one particular frequency more than one time or for a longer duration to increase the signal-to-noise ratio at the at least one particular frequency.

13. The seismic exploration system of claim 8, the data processing system further configured to:
determine, by comparing the incomplete data subset to the complete dataset, whether the incomplete data subset deviates from the complete dataset by more than a predictable amount;
based on the determination, receive data based on a third emitted signal as a second complete dataset, the third emitted signal spectrum is constituted of a range of frequencies between a starting frequency and a stopping frequency;
create a second reconstructed dataset by supplementing the incomplete data subset with the second complete dataset; and
generate a seismic image based on the second reconstructed dataset.

14. The seismic exploration system of claim 8, wherein at least one of the first emitted signal or the second emitted signal is emitted by a SEISMOVIE™ source.

15. A non-transitory computer-readable medium, comprising:
computer-executable instructions carried on the computer-readable medium, the instructions, when executed, causing a processor to:
receive data based on a first seismic signal as a complete dataset, the first emitted signal is a range of frequencies between a starting frequency and a stopping frequency;
receive data based on a second emitted signal as an incomplete data subset, the second emitted signal is a subset of the frequencies used by the first emitted signal between the starting frequency and the stopping frequency;
create a reconstructed reflected dataset by supplementing the incomplete data subset with the complete dataset; and
generate a seismic image based on the reconstructed dataset.

16. The non-transitory computer-readable medium of claim 15, wherein the second seismic signal is based on an undersampling factor or a frequency subset.

17. The non-transitory computer-readable medium of claim 16, wherein the undersampling factor is selected based on decreasing a total emission time of the seismic source.

18. The non-transitory computer-readable medium claim 15, wherein the second seismic signal is comprised of at least one monofrequency.

19. The non-transitory computer-readable medium of claim 15, wherein the second seismic signal further includes:
selecting at least one particular frequency based on a signal-to-noise ratio; and
emitting the at least one particular frequency more than one time or for a longer duration to increase the signal-to-noise ratio at the at least one particular frequency.

20. The non-transitory computer-readable medium of claim 15, further comprising:
determine, by comparing the incomplete data subset to the complete dataset, whether the incomplete data subset deviates from the complete dataset by more than a predictable amount;
based on the determination, receive data based on a third emitted signal as a second complete dataset, the third emitted signal spectrum is constituted of a range of frequencies between a starting frequency and a stopping frequency;
create a second reconstructed dataset by supplementing the incomplete data subset with the second complete dataset; and
generate a seismic image based on the second reconstructed dataset.
